(19) United States
(12) Patent Application Publication
(10) Pub. No.: US 2007/0244760 A1
(43) Pub. Date: Oct. 18, 2007

(54) Digital media exchange

(75) Inventors: Guillermo Bodnar, Chantilly, VA (US); Bob Barbiere, Randolph, NJ (US); Chi Eng, Wayne, NJ (US)

Correspondence Address: Alfred W. Froebrich, Esq.;Cohen Pontani Lieberman & Pavane LLP, Suite 1210, 551 Fifth Avenue, New York, NY, 10176, US

(73) Assignee: Arbinet-thexchange, Inc.

(21) Appl. No.: 11/788,631

(22) Filed: Apr. 20, 2007

Related U.S. Application Data
(63) Continuation-in-part of application No. 11/409,758, filed on Apr. 24, 2006.
(60) Provisional application No. 60/793,496, filed on Apr. 20, 2006.
(60) Provisional application No. 60/729,922, filed on Oct. 25, 2005.

(51) Int. Cl. G06Q 40/00

(52) U.S. Cl. 705/14

(57) ABSTRACT

A method for facilitating the trading of media space includes collecting, by a server node, an offer of an ad avail from a seller and a request for an ad avail by a buyer. The offer is in effect for a fixed time period and includes a first price at the commencement of the fixed time period and a second price at the end of the fixed time period. A price-time relationship for the ad avail is specified by the seller such that the price of the ad avail varies over the fixed time period. The server node matches the request to the offer at time t₁ during the fixed time period and the server node computes a price for the ad avail based on t₁ using the price-time function.

### CROSS-REFERENCE TO RELATED REFERENCES

This application claims priority to U.S. Provisional Application no. 60/793,496, filed on Apr. 20, 2006 and is a Continuation-in-Part of U.S. patent application Ser. No. 11/409,758 filed on Apr. 24, 2006, which in turn claims priority to U.S. Provisional Application No. 60/729,922 filed on Oct. 25, 2005. The entire contents of all of these documents are collectively incorporated herein by reference.

### BACKGROUND OF THE INVENTION

1. Field of the Invention

The present invention relates to methods and systems for trading digital media space and more specifically, a cost-efficient transaction management platform for the advertising industry.

2. Description of the Related Art

Various innovations in communications technology allow consumers to now receive information from increasingly diverse, user-driven media outlets. Aside from traditional analog televisions, radios, and print publications, many consumers can now be reached through a number of new media such as, for example, Web publications, video-on-demand, podcasting, mobile phones, digital cable and satellite sub-channels, user-generated content websites, online video games, and satellite radio. Thus, consumers' attention is increasingly ensnared (and fragmented) by a bewildering array of new media outlets. As a result, advertisers struggle to manage their advertising campaigns in this highly fragmented information era, as the traditional method of negotiating with each mass media outlet (e.g., TV networks and online content distributors) on a one-to-one basis and exchanging paper forms becomes increasingly costly, cumbersome and unmanageable. The risk of lost forms and human errors also increase substantially. From the perspective of media sellers, such as local TV stations with coverage in various geographical markets, the traditional labor-intensive process can cost them business opportunities, as the advertisers would opt to buy from mass media such as broadcast or cable network television in a single transaction rather than engaging in myriad transactions with multiple local media outlets.

Nonetheless, this new digital information age, though more complex than the old, could generate hitherto unimaginable marketing opportunities and efficiencies, resulting in an increase in wealth generating potential for the advertising industry. In this world of fragmented and varied media outlets, determining or evaluating the suitability of each opportunity will require more research, analysis, and interactivity.

Moreover, the traditional notions of “reach, frequency, exposure and cost per thousand” as the currency for advertising do not correlate well to a world less dominated by TV broadcasting, where streaming applications such as podcasting and video-on-demand provide alternative means to deliver entertainment content to the consumers—at a time and place dictated by the consumers. New metrics and currency must also be developed for this new advertising era.

Accordingly, there is a need for a scalable technological platform that would solve the above problems for the advertising industry in a highly fragmented digital information era, where the influence of mass media may occupy a less dominant position.

### SUMMARY OF THE INVENTION

An object of the invention is to provide a cost-efficient, automated system for facilitating the trading and settlement of electronic media space between marketers (or their advertising agents) and media sellers.

Another object of the invention is to provide a technical platform that would optimize the transactions between advertisers or marketers and sellers of media space in the digital world, increase the cost and performance effectiveness of advertising campaigns, and which is scalable to accommodate numerous buyers and sellers of media space.

Another object is to provide a digital media exchange to enable advertisers or marketers to engage in integrated marketing.

Still another object is to provide an electronic trading platform that will make the ad placement process more efficient, reduce the number of errors and time wasted as a result of people having to communicate via telephone and fax and re-key information.

Yet another object is to provide buyers and sellers of media space the opportunities for increased business, and to free up more time and resources for generating new ideas and improving the advertising creative.

In one embodiment, a server node facilitates the trading media space by receiving from sellers offers of ad avails for a fixed time period including an opening price at the commencement of the fixed time period and an end price at the end of the period. The sellers then specify a price-time relationship for the ad avail such that the price of the ad avail varies over the fixed time period. The price of the ad avail preferably varies inversely with time, i.e., decreases over the fixed time period. The price-time function may be supplied by the seller or selected from one of several standard functions provided by the trading platform. The server node also receives requests for ad avails from buyers. When the user-input parameters present conditions for matches during the fixed time period, the server node identifies the matched requests and offers and notes the time of the match, t₁. The server node computes the price of the ad avails corresponding to t₁ using the seller-selected price-time function, and facilitates delivery of the ad creative from the buyers to the sellers.

In another embodiment, there is provided an online Digital Media Exchange (“DME”) platform that aggregates advertisers or marketers (“Buyers”) and media sellers (“Sellers”). It provides a standard interface accessible by Buyers and Sellers to facilitate the buying, selling, delivery, and settlement of all forms of digital advertising across all electronic advertising media. Through this platform, advertisers will be able to purchase everything from a WAP banner for a mobile device to an audio/video commercial spot during an IPTV broadcast, without requiring exhaustive labor-intensive searches of numerous media outlets or opportunities. Preferably, the platform also facilitates the delivery of the advertising content or information between the Buyers and Sellers by, for example, coordinating the respective information systems of the Buyers and Sellers or providing a central repository of the advertising content or information for efficient delivery and inventory management. Users will be provided with the abilities to identify, price, and deliver the most effective media, style, demographics and/or content affiliation for an advertising campaign that is within their budget.

The DME platform is comprised of many processes and system components to provide Buyers and Sellers a smooth, reliable, seamless, real-time, web-based application to buy and sell digital media space, or digital advertising. The DME, preferably constructed as a full-service, internet-based trading platform includes back-office processes so that Buyers and Sellers will be able to electronically transact, deliver, and settle digital media advertising in real time in an unbiased, neutral environment operated by an independent third-party operator (who is not affiliated with the Buyers or Sellers).

The DME may be a member-based exchange available to all qualified Buyers and Sellers (or their agents). To maximize the usefulness of the DME, prospective members would be required to fill out applications, preferably online applications, and provide information relating to, for example, creditworthiness (if they are to become buyers), bank accounts (to enable automated settlement of transactions), corporate formation, brief description of available media space or content (if Sellers), contemplated advertising campaigns (if Buyers), and intellectual property rights ownership of the underlying works in the advertisement. Each of the prospective members may further be required to execute an exclusivity agreement with the DME operator so as to prevent the members from engaging in transactions outside the DME platform. Since the Buyers and Sellers as they would likely consider the submitted information as competitively sensitive, the DME operator preferably remains neutral to the transactions and maintains confidentiality of the application information and transaction data to earn the trust of the Buyers and Sellers. The entered information is automatically stored and indexed by the DME for settlement and other DME operations.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic overview diagram of a Digital Media Exchange (DME) according to an embodiment of the present invention;

FIG. 2 is an example of a user interface screen presented to a buyer member;

FIG. 3 is a schematic diagram depicting a one-to-one service of the DME;

FIG. 4 is a schematic diagram depicting a many-to-many service of the DME;

FIG. 5 is a schematic block diagram showing various systems of the DME;

FIG. 6 is a flow diagram showing steps performed between a buyer and the DME;

FIG. 7 is a flow diagram showing steps performed between a seller and the DME;

FIG. 8 is a graph depicting a price-time relationship of an avail; and

FIG. 9 is a flow diagram showing steps performed according to an embodiment of the invention.

### DETAILED DESCRIPTION OF THE PRESENTLY PREFERRED EMBODIMENTS

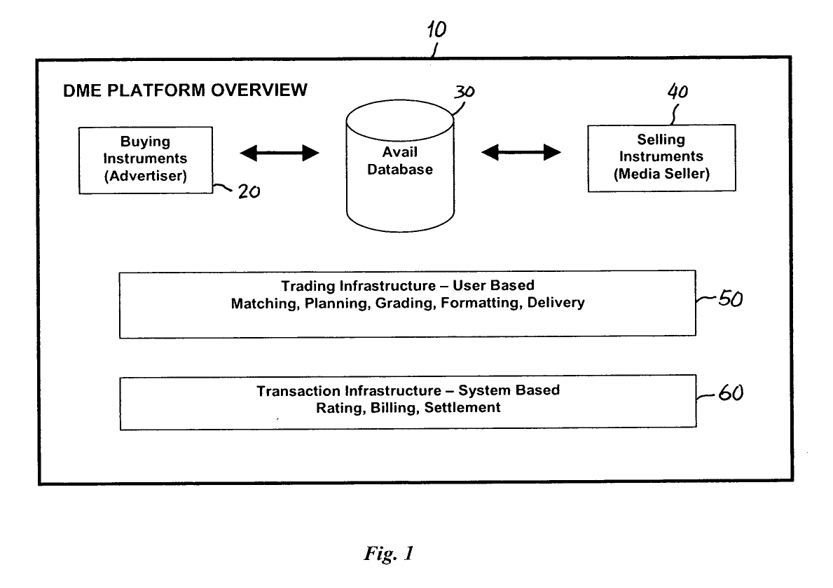

FIG. 1 diagrammatically illustrates the various component modules of a DME platform 10 according to an embodiment of the present invention that aggregates advertisers or marketers (Buyers) and media sellers (Sellers). The Buying Instruments 20 and the Selling Instruments 40 interact with an Avail Database 30, which stores the records of the avails in a searchable format. A Trading Infrastructure 50 enables matching, planning, grading, formatting, and delivery of the ad creative between matched Buyers and Sellers. Preferably, the Trading Infrastructure 50 is configured to rate, bill, and settle the executed trades. The Trading Infrastructure 50 may perform such tasks in accordance with the agreed pricing models including, for example, CPM (i.e., cost per thousand impressions), click-through, pay-per-click, estimated impressions per day, pay-per-click, referral fees, pay-per-action, pay-per-order.

Buyers 20 may access the DME's buying instruments to navigate through the digital advertising inventory of available advertising space offered by Sellers 40. Sellers 40 may also access the DME's selling instruments and review Buyers' marketing campaign parameters. Preferably, the DME Trading Infrastructure 50 will compile user (buyer and seller) input and process the data using business rules to effectively broker and execute transactions between buyers and sellers. A Transaction Infrastructure 60 will compile system input and deploy the data to effectively register and settle all DME transactions. Upon execution of the trade, it will also provide grading, formatting, and facilitate delivery of the ad creative to the traded digital media space.

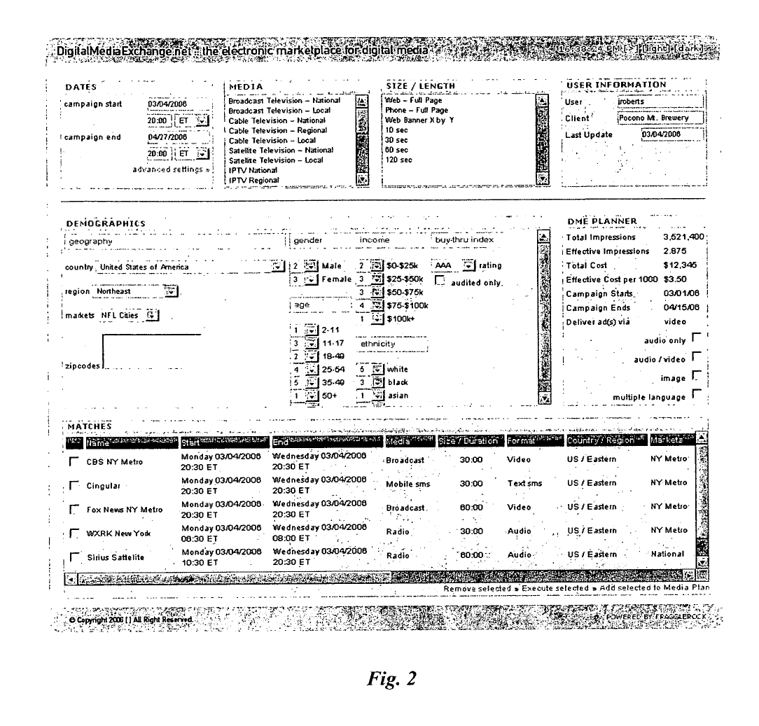

FIG. 2 illustrates an example of a user interface form for member Buyers. The form requests Buyers to provide, for example, the advertising campaign period, the desired media outlet, the size/length of the digital advertisement, user information, the desired demographics, and parameters relating to the desired content-type affiliations. Content affiliation parameters allows a marketer to associate a promoted brand with a desired audio/video content such as a short movie, a television series, a music video, etc. Example of such parameters may include those ratings used for rating and characterizing movies and video games (e.g., “G” for general audience, “M” for mature audience, “5” for the number of stars signifying the degree of popularity). There is also provided a planner (which computes the impressions, costs, etc. using approved pricing models) for the Buyers.

The user interface may optionally display, in real time, the possible matches using business rules defined by the members or by the DME operator. Various pricing techniques may be used to price the available inventories.

The DME user interface preferably provides members the ability to: (i) Track past, current, future transactions and results; (ii) Access financial and credit information; (iii) Review past, current, and future avail inventory; (iv) Access uploaded digital ads files; and (v) Input avail parameters that assist Arbinet-Ad Match in locating corresponding inventory.

Sellers may be provided with an interface for the input and management of their ad inventories or avails. Sellers are requested to describe their avails (e.g., type, engagement periods, frequency), demographics associated with the offered media space, price, and other information necessary for Buyers to determine the suitability of the avails for their advertising campaigns. Sellers may be provided with a set of business rules to search for available advertising campaigns. Similarly, Buyers may also be able to input a set of business rules to automate searching and matching of eligible avails.

The DME 10 may offer at least two different options for Buyers 20 and Sellers 40 to transact digital media with one another. Traditional media buying is done as a one-off buyer/seller transaction in which an advertiser (or its agent) would purchase advertising inventory from media sellers (e.g., a major TV network). This results in a one-to-one relationship in which a single buyer buys from a single seller. The DME 10 may offer a service called “Select-Buying,” which enables the Buyer 20 to manually select the desired ad avails. Under this service, Buyers 20 provide requested inventory parameters using the user interface described above, and the DME 10 automatically locates and displays, to the Buyer 20, avails that meet or substantially meet the Buyer's initially specified criteria. Buyer 20 may then select the avail(s) they elect to purchase. The Select-Buying Service is illustrated in FIG. 3, in which Buyer 20 reviews and selects a Seller's avail. The Buyer 20 purchases that avail in its entirety. Seller 40 receives all insertions/impressions from the Buyer 20 for the avail(s).

The DME 10 may also provide another unique and effective means of buying and selling advertising inventory using a service called “Optimized Buying.” Optimized Buying analyzes the Buyer's specified parameters (e.g., demographics) and matches Buyers 20 to Sellers 40 based on Buyer's requested user demographics and a specified budget for the campaign in a many-to-many scenario (i.e., multiple buyers to multiple sellers) that is simple, effective, and transparent to both parties. Once matched, a Buyer's advertising creative is delivered to the matched Seller and, preferably, inserted into the purchased media space. According to one embodiment of the “Optimized Buying” service, the seller's avails may be parsed by the DME into portions which meet the requirements of particular Buyers. For example, a buyer desiring certain consumer age and income brackets specified TV as its preferred media, may be matched to sellers of web-space or radio spots having an audience that would meet the buyer's consumer age and income requirements. In this way, Sellers get their avails more effectively filled via multiple buyers. The Optimized Trading system is fluid and dynamic thereby producing real-time market pricing based on supply and demand.

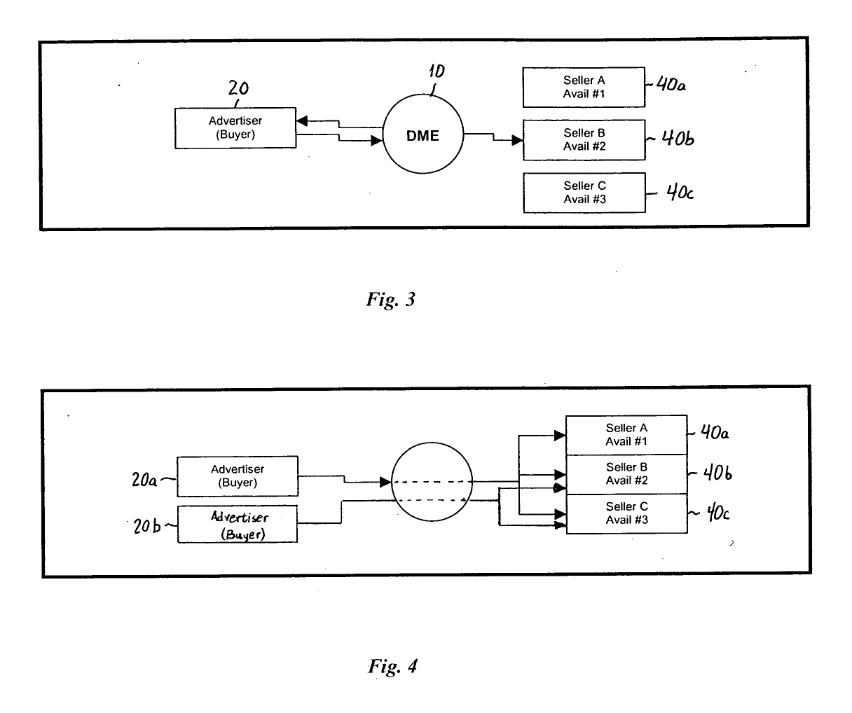

As depicted in FIG. 4, Buyers 20a, 20b input order requirements including demographics for its advertising campaign. The DME 10 identifies all available media space matching those requirements. The DME 10 then allows Buyer 20a, 20b to purchase insertions/impressions across all sellers 40a, 40b, 40c meeting matched its order requirements. In the specific embodiment shown in FIG. 4, buyer 20a is matched with sellers 40a, 40b, and 40c. Buyer 20b is matched with sellers 40b and 40c.

Digital Media Exchange Platform Components

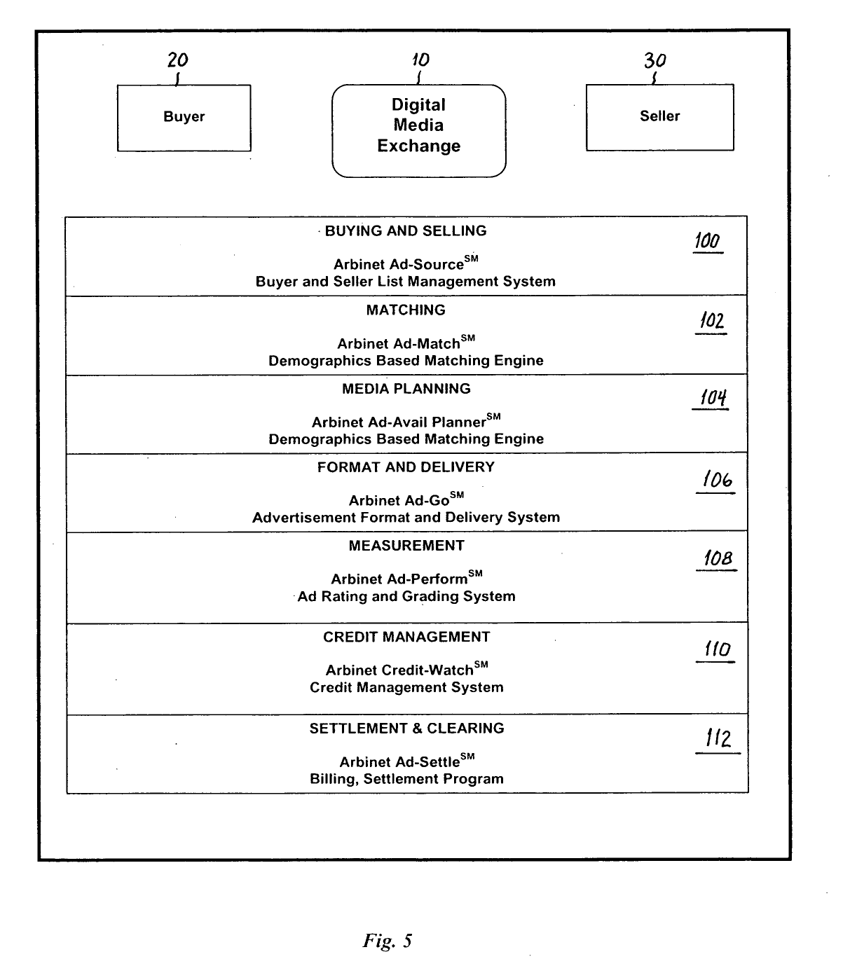

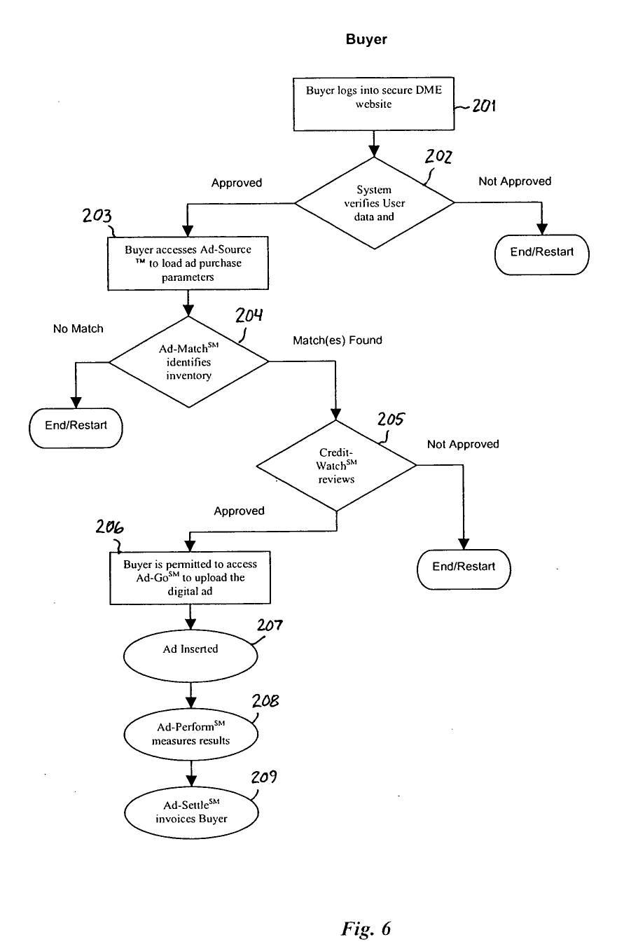

FIG. 5 further illustrates in greater details the various components of the DME 10, whose functionalities are described as follows.

The DME includes a web-based user interface for the order entry and order management associated with buying and selling digital media advertising. The Ad-Source^{SM} interface 100 will specifically provide buyers 20 with tools to identify and acquire advertising opportunities based on ad/media attributes, cost, and demographic parameters. Sellers 40 will have the ability to offer advertising along with associated media attributes, demographics and cost information. It also provides Sellers 40 the tools to offer for sale and manage their inventories.

Ad Source^{SM} interface 100 solicits the following information from Buyers and/or Sellers for the Ad-Match^{SM} module 102 (described below) for identifying suitable ad inventories for their ad campaign(s). Buyers may provide some or all of the information in order to refine their matches.

1. Buy/Sell Type
a) Select (Buyer selects actual avail(s))
b) Optimized (Buyer provides order parameters and DME purchases matched avails on a per impression basis).
   Purpose: Users decide whether they are going to buy/sell an avail via Select or Optimized service on a per-order basis.

2. Avail Type
a) Timed (Hard start and end date)
b) Per insertion
c) Per Impression
   Purpose: Buyers and Sellers select whether they are going to buy/sell an avail by a) duration, b) duration of insertions, c) duration of impressions or by any other metrics depending upon the pricing models and type of media space. Buyers and Sellers will have the ability to propose a maximum number of impressions per day/week/month/period on a per order basis. Buyers and Sellers will also specify the pricing models for settlement purpose. Preferably, a standard pricing model will be associated each avail type.

3. Timing—Campaign/Avail (Required)
a) Start Date
b) End Date (with Good Till Cancel or Max Insertion/impression option)
   Purpose: The Buyer and Seller define the commencement, completion and max insertion/impression on a per-order basis.

4. Frequency
a) Per month, week, day, time
b) Per insertion
c) Per impression
   Purpose: Sellers would identify the expected frequency of the avail insertions or impressions on a per order basis.

5. Media Segment (Required)
a) Mobile
   i. Phone
      (a) On-Deck, Off-Deck, Wap, MMS, SMS
   ii. Portable—Music/Video
   iii. Portable—Other
b) Web
c) Digital Cinema
d) Television
   i. Network
   ii. Cable
   iii. Satellite
   iv. IPTV
e) Radio
   i. Terrestrial
   ii. Satellite
f) Hotel/Hospitality
g) Print
   Purpose: Buyer and Seller would identify the specific media segment of the avail they are buying or selling on a per order basis.

6. Ad Type (required)
a) Image
b) Audio (only)
c) Video (with audio)
   Purpose: Buyer and Seller identify the type of digital ad they are buying or selling on a per order basis.

7. Style (Required)
a) Spot
b) Stock
c) Search
d) Banner
e) Bumper
f) Insert
g) TMBA (Targeted Mobile Brand Advertising)
h) Other
   Purpose: Buyer and Seller identify the style format of the ad they are buying or selling on a per order basis.

8. Dimensions (Required)
a) Size
b) Length
c) Format
   Purpose: Buyer and Seller identify the dimensions and format of the ad they are buying or selling on a per order basis.

9. Demographics (Optional)
a) Country(s)
b) Region(s)
c) Market(s)
d) Zip Code(s)
e) Gender
f) Age Group(s)
g) Income Group(s)
h) Ethnicity(s)
   Purpose: Standard advertising/media category breakdowns may be employed by the DME. Buyer and Seller identify the demographics they expect to buy or sell to on a per order basis. Each category within the demographics will carry an “effective” grade of 0 to 5 (5 being the highest). Seller's effective grades will either be loaded by the seller (unaudited), or provided by the DME (audited) on a per order basis.

10. Performance Indices (Optional)
a) Audited/Unaudited (DME verified delivery results)
b) Corporate Rank (Common industry ranking such as Fortune 500)
c) Performance Grade—As available (Additional data and metrics associated with an avail that may include click-thru response rate, bar-code scan rate, buy-through rate, etc.)
   Purpose: Buyer identifies if they want to be matched to sellers by Performance Indices on a per order basis. Sellers provide their expected demographic and performance indices (unaudited) which are subsequently updated when/where the DME has verified the results (audited).

11. Budget (Required)
a) Per Plan
b) Per Segment
c) Per Insertion
d) Per Impression
   Purpose: Buyers and Sellers identify the rate/cost they are willing to buy/sell the avail by plan, segment, insertion, or impression; on a per order basis.

The Ad-Match^{SM} campaign management module 102, on a per order basis, compares the buy order data of all (or selected) Buyers 20 to the sell order data of all (or selected) Sellers 40.

In the case of initial order review or Select Service, matches are presented to Buyer or Seller for either party to determine if they would like to engage in a Select one-to-one transaction.

For Optimized Service, matches are presented to Buyer or Seller with either party having the option to omit selected matched counter orders. The remaining matched orders that are actively engaged by both parties form the media plan for an individual order.

Each new buy or sell order will be immediately matched to counterparty orders. Where matches occur an individual order media plan will be generated and submitted to both parties. The media plan will immediately become active. Preferably, all active buy and sell orders are re-matched at predetermined intervals. Optimized buy and sell orders have dynamic parameters that would cause the matching and unmatching of orders as data changes.

In a specific embodiment Buyers and Sellers may agree to be automatically engaged by a contract when a match is found so that no acknowledgement is required from either party to effect the transaction once a match is made. In this specific embodiment, the parties agree to be held to the terms of a contract prior to the match being made. Accordingly, once a match is found, the trade can be implemented immediately. The buyer may set a spending limit. For example, a buyer may agree to be automatically bound to matches up to $5000.00.

Ad-Avail Planner^{SM} application 104 provides Buyers and Sellers with transaction confirmation, instructions for an Ad-Go^{SM} application 106 (described below), and active delivery/results information on a per order basis.

Buyers and Sellers use the Ad-Avail Planner^{SM} application 104 to track individual or aggregate Buy and Sell orders along with post purchase results. Results are published during and post purchase and are updated at a predetermined frequency, e.g. (x) times per day. Buyers or Sellers can control their respective budget and maximum impression cap (if applicable) on a per order, per project, or per member basis.

Ad-Go^{SM} delivery application 106 supports the formatting and delivery of the digital media. Once a transaction is confirmed by the Ad-Avail Planner^{SM} application 104, the Ad-Go^{SM} application 106 provides communication to the Buyer and Seller which includes the required format, delivery, and timing of the digital media (digital ad). Formatting may be required of images, audio, and video and include (but not limited to) media file dimensions, media segment, device, market, language.

For Select Service, the Buyer (on a per order basis) will determine whether it will provide the Seller with the final formatted digital media file(s) via DME or whether they will provide the DME with a “raw” unformatted digital media file(s) that will require the DME to format and transport/deliver to Seller.

For Optimized Service, the Buyer (on a per order basis) will determine whether it will provide the DME with the final formatted digital media file(s) or whether it will provide the DME with a “raw” unformatted digital media file that will require the DME to format. Additionally the Seller will determine whether it will retain the digital file(s) within their server/delivery infrastructure or whether it will “dip” into the DME's central or remote server on a daily or per impression basis.

Ad-Perform^{SM} measurement application 108 determines and/or measures quality, demographic, and impression performance information. It uses this information to establish performance metrics that assist DME Buyers and Sellers and for settlement purpose in accordance with the agreed pricing model(s). Ad-Perform^{SM} application 108 may receive data from internal and external sources pro-actively or reactively. As described below, the Ad-Perform application 108 determines or measures avail demographics, impression detail records, and click-through and buy-through performance.

For determining avail demographics, the Ad-Perform^{SM} application 108 proactively accesses the address (if available) of an ad avail offered by a Seller to determine likely demographics of the users. This would include the use of words, phrases, images, data commonly associated with certain demographics. (For example—if the Ad-Perform^{SM} application 108 reviews a new avail sell order and determines the content is exclusively women's jewelry, then the Ad-Perform^{SM} application 108 will be able to determine that one of the common demographics for that avail is “female”). Furthermore, the Ad-Perform^{SM} application 108 reviews prior Seller and avail history to determine commonality to the new order for determination of common demographics. (For example—the Ad-Perform^{SM} application 108 matches this avail sell order to one that is identical to a prior sell order in which the demographics were determined to be male, 18-35, $150,000 plus income). The Ad-Perform^{SM} application 108 determines the commonality in demographics and provides that with the order. In these cases the Ad-Perform^{SM} application 108 audits the demographics presented by the Seller for confirmation. Should the Ad-Perform^{SM} application 108 verify the Seller demographics as being correct, the sell order will be considered “audited” and Buyers may select “audited” as a matching criteria.

For determining impression detail records, the Ad-Perform^{SM} application 108 may also accept real-time and post sale demographic data from sellers. The Ad-Perform^{SM} application 108 will create an IDR (Impression Detail record) for all impression based orders or the number of clicks for click-through pricing model or any metrics required by an agreed pricing model. The Ad-Perform^{SM} application 108 may also deploy organic or purchased technology to pro-actively determine the insertion/impression, volume and/or demographic information on a per insertion, per impression, or per order basis. This information will be used in the performance grading of the seller and avail. The IDR where available will be used in a Credit-Watchs^{SM} module 110 and an Ad-Settle^{SM} application 112 and processes.

For determining click-through and buy-through performance, the Ad-Perform^{SM} application 108 will track the user's immediate response to an ad. These responses can include (but not be limited to) requesting more information, downloading information, presentation of POS data such as bar code, and actual purchase.

Data collected and determined by the Ad-Perform^{SM} application 108 may be used to assist DME Buyers and Sellers to make more efficient and effective decisions in the buy/sell process.

Arbinet Credit-Watch^{SM} credit management module 110 provides Buyers and Sellers with credit management instruments. All DME transactions are rated and cleared via the Ad-Settle^{SM} application 112 and posted to the Credit-Watch^{SM} module 110. This allows the DME to effectively and accurately present Buyers and Sellers with applicable financial information.

Credit-Watch^{SM} module 110 manages active Buyer and Seller credit balances and notifies users on such balances at predetermined thresholds. Further, the Credit-Watch^{SM} module will provide notice and cease delivery of digital media in cases where a Buyer has exceeded its pre-established credit limit.

Arbinet Ad-Settle^{SM} mediator application 112 rates, mediates, bills, and settles all DME transactions. The rating and mediation of a transaction is based upon the Buy/Sell, Avail Types, and pricing model(s). Billing and settlement are typically standard for all DME participants on a predetermined payment periods.

The DME operates for the Buyers in the manner outlined in FIG. 6 and described as follows. Initially, Buyer logs onto the secure DME website, step 201. The DME system authenticates Buyer's log in information and verifies whether Buyer is in good standing, step 202. If approved, the system allows the Buyer to access Ad-Source interface 100 to load ad purchase parameters, step 203. Ad-Match module 102 searches and identifies available inventory for possible matches using user-supplied or DME-provided business rules including rules for automatic execution of a legally binding transaction, step 204. If a match is located, the Credit-Watch module 110 reviews the available credit in the Buyer's account with the DME, step 205. If approved, Buyer may access Ad-Go application 106 to upload the digital advertisement, step 206, for insertion in the desired media space of the matched Seller(s), step 207. Ad-Perform application 108 measures performance results of the inserted advertisement, step 208. Ad-Settle application 112 then settles the executed transaction and generates an appropriate invoice based on the agreed terms between the matched Buyer and Seller(s), step 209.

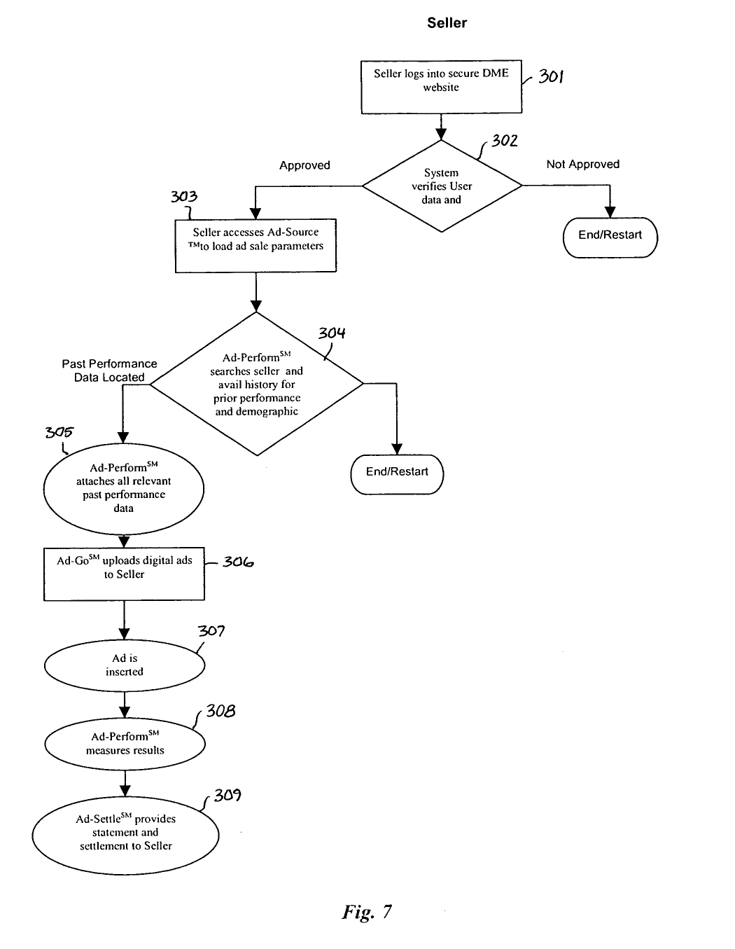

FIG. 7 illustrates the interaction between the DME and the Seller. Seller supplies user information and other authentication information to the DME, step 301. The DME verifies the user data, step 302. If approved, Seller is allowed to Ad-Source interface 100 to load ad sale parameters, step 303. Ad-Perform application 108 analyzes the sale parameters and conducts a search of the Seller's avail history for prior performance and demographics, step 304. Once past performance data is located, Ad-Perform application 108 attaches all relevant past performance data, step 305. Ad-Go application 106 uploads the digital ads to Seller, step 306, and Ad creative is then inserted, step 307. Ad-Perform application 108 measures and records results of the advertising campaign, step 308. Ad-Settle application 112 settles the transaction and provides a statement detailing the executed transaction to Seller, step 309.

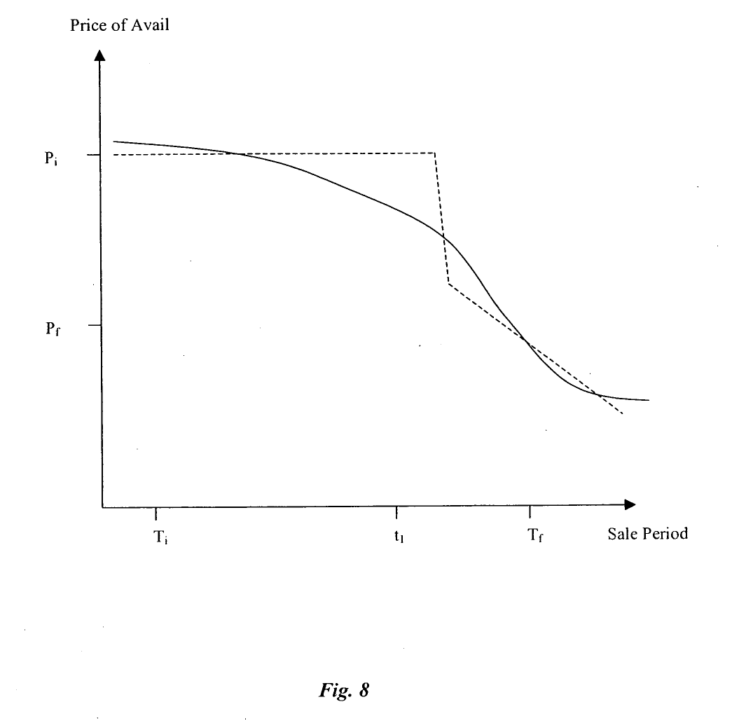

In another preferred embodiment, Sellers agree to sell their avails for a limited period of time at a price that would vary according to the level of demand. Sellers will be required to enter a price range for each of its avails, with the highest price offered for the start date and the lowest price offered for the end date, and chooses a price-time relationship provided by the DME. For example, a linear relationship may be used to compute the intermediate prices between the start and end dates for the avail. Alternatively, a nonlinear price-time relationship (e.g., a step-function or a quadratic relation), such as that shown in FIG. 8, may be employed to determine the intermediate prices. This decreasing price relationship (linear or nonlinear) reflects the perishable nature of an avail that will expire if not sold earlier. Thus, for example, a television spot for a TV show that remains unsold will have no value after the TV show is broadcast. With this understanding, a seller would place a higher value for its avail(s) on the commencement date; and a lower value on the end date. The selected price-time relationship will remain undisclosed to the Buyers. From the Buyer's perspective, the higher price of an avail is justified if it meets the requirements of the Buyer's ad campaign. Buyer is also incentivized to execute a transaction to purchase the avail early on instead of waiting for the price of the avail to drop, since the availability of the ad avail remains uncertain due to the presence of multiple competing buyers. The Buyer will feel pressured to act sooner rather than later, if the DME also reports multiple matching of the avail to requests from multiple buyers. Moreover, Sellers will be more likely to use the DME (by offering greater number of avails on the DME) as they will appreciate that the DME offers them a viable opportunity to maximize their revenue, thereby further increasing the liquidity of the exchange. Buyers' ability to more efficiently manage ad campaigns will be enhanced by the greater diversity and number of avails available on the exchange.

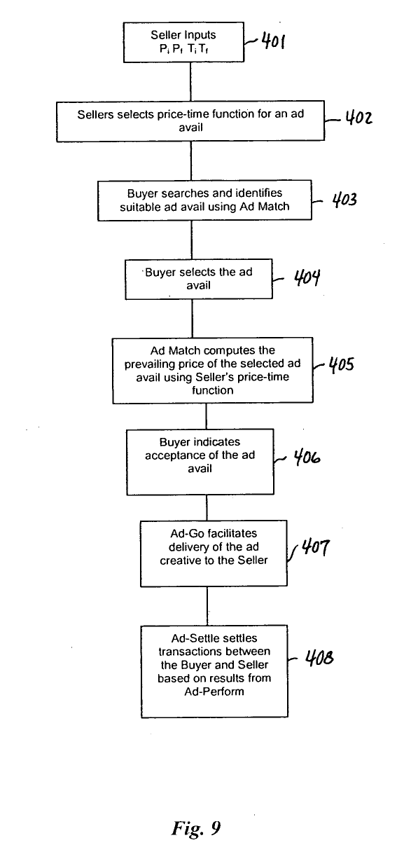

In operation, as shown in FIG. 9, the Seller offers an ad avail for sale on the DME, chooses a pricing model (e.g., number of click-throughs) and specifies a fixed period of time for which the ad avail is available, by selecting an opening price at the beginning of the sale period and an end price (which is lower than the opening price) at the end of the sale period, step 401. The seller then either picks one of several price-time relationships offered by the DME or supplies one of its own, step 402. Ad-Match identifies a matched buyer for the offered avail during the fixed time period, step 403. The buyer selects the ad avail, step 404 and the DME computes the sale price at the time of the match, t₁, using the selected price-time function, which sale price will be used by Ad-Settle to settle transactions between the Buyer and the Seller, step 405. Once the buyer accepts the matched ad avail, step 406, the Ad Go facilitates delivery of the ad creative to the seller, step 407, and Ad-Settle settles the transaction, step 408.

Optionally, instead of computing the sale price when a match is identified, the current price of an avail at a time t₁ may be used to decide whether a match is made or not in the case of Optimized Service. For example, a buyer may not wish to spend more than a predetermined amount for an avail. In this case, the DME constantly updates the current price of an avail for the benefit of the buyer based on the selected price-time relationship as long as the avail remains available. When the price of that avail reaches the predetermined amount, i.e., at time t₁, the DME produces a match.

In yet another embodiment, the DME, as a neutral, objective and trusted entity, may provide numerous online tools to help Buyers and Sellers achieve their respective objectives. For example, the DME could provide real time feedback to Buyers through Ad-Perform, and if the campaign objectives are not met (e.g., insufficient “eyeballs”, “impressions”, “reach”, “conversion rate”, etc.), Buyers will be so informed. And Buyer may be prompted to obtain additional avails and/or modify its ad creative in order to achieve its stated campaign objective. Optionally, Ad-Match continues to identify new avails which match the Buyer's campaign parameters. The results may be presented to the Buyer for approval or the DME will automatically facilitate the delivery of the ad creative to the new sellers. The DME could also chart ad expenses incurred in real time based on the agreed pricing models (e.g., pay-per-click, pay-per-impression, etc.) against a previously specified budget so that the marketing executive would not overspend her campaign budget.

The DME may compare and analyze the real time performance feedback on each avail with the demographics and other consumer profile data provided by the Sellers. When the performance results are due to inaccurate postings by the Sellers, automatic alerts will be sent to the Sellers, and could result in the unmatching of the previously matched Buyers and Sellers at the next predetermined interval.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for facilitating the trading of media space, comprising the steps of:
collecting, by a server node, an offer of an ad avail from a seller, the offer being in effect for a fixed time period and including a first price at the commencement of the fixed time period and a second price at the end of the fixed time period;
collecting, by the server node, a request for an ad avail from a buyer;
specifying, by the seller, a price-time relationship for the ad avail such that the price of the ad avail varies over the fixed time period;
matching, by the server node, the request to the offer at time t₁ during the fixed time period; and
computing, by the server node, a price for the ad avail based on t₁ using the price-time function.

2. The method of claim 1, further comprising the step of executing a trade between the buyer and the seller upon receiving a signal indicating acceptance of the ad avail from the buyer.

3. The method of claim 2, further comprising the step of facilitating delivery of an ad creative from the buyer to the seller based on the computed price.

4. The method of claim 1, wherein said step of matching is based on the computed price of the offer, the price entering an acceptable range of the buyer at the time t₁.

5. The method of claim 1, wherein the server node collects multiple offers from a plurality of seller and multiple requests from a plurality of buyers, said step of matching comprising matching at least a portion of two different ones of the offers from two different ones of the sellers to fulfill a single buyer's request.

6. The method of claim 1, wherein the server node collects multiple offers from a plurality of seller and multiple requests from a plurality of buyers, said step of matching comprising matching at least a portion of two different ones of the requests from two different ones of the buyers to fill a single seller's offer.

7. The method of claim 1, further comprising the step of automatically binding, by the server node, the seller and the buyer to a contract upon performance of said step of matching.

8. The method of claim 7, wherein the request includes an upper spending limit, said method further comprising performing said steps of matching and binding for the buyer until the upper spending limit is reached.

9. The method of claim 1, further comprising the step of displaying the computed price to the buyer for acceptance.

10. The method of claim 1, wherein the price-time relationship comprises a price that decreases from the commencement of the fixed time period to the end of the fixed time period.
